(19) United States
(12) Patent Application Publication
(10) Pub. No.: US 2012/0324006 A1
(43) Pub. Date: Dec. 20, 2012

(54) MULTI-TOUCH FOR CLOUD COMPUTING

(76) Inventor: FRANK JOSEPH GAROFALO, Redlands, CA (US)

(21) Appl. No.: 13/507,132

(22) Filed: Nov. 7, 2010

(51) Int. Cl. G06F 15/16

(52) U.S. Cl. 709/204

(57) ABSTRACT

Systems and methods are presented in this document for connecting multiple users in remote locations to simultaneously collaborate through multi-touch devices. Any number of multi-touch devices will be capable of being connected through an Internet connection to a web server (also referred to as “cloud computing”). The user interface displays of the multi-touch devices will update each of the displays in real-time through the Internet connection to the web servers. This system will enable users to host sessions, such as conference meetings, with participants in various remote locations. At each location participants will be able to utilize the physical and interactive capabilities of a multi-touch device.

### RELATED APPLICATIONS

No related applications have been filed pertaining to this specific application.

### TECHNICAL FIELD

This present invention relates to the system and method of linking any number of multi-touch devices over a network or Internet connection to have each multi-touch device synchronize the visual displays. More specifically, users will be able to establish a session with a unique invitation code, any number of multi-touch devices will be able to join a single session. As a user interacts with one multi-touch device within a session, all the other devices linked in the same shared session will also have their screens updated.

### BACKGROUND

“Touch is a very natural and intuitive way for people to interact,” stated Jeff Han, as he described the interaction and experience capabilities multi-touch devices provide to individuals. However to-date, businesses still have the challenge of empowering their associates in various remote locations to meet and collaborate. When travel expenses are not an option within the budget for companies, the alternatives are, for example, telephone conference calls, video conference calls, and web-based video-audio sessions. Each of these options lacks the ability for individuals to utilize their sense of touch while collaborating.

Multi-touch devices with the ability to simultaneously sense at least three (3) touch inputs allow for the ability for more than one individual to interact with the device at any given moment. Within this documentation, “multi-touch device” will reference a touch-sensing device with the ability to detect a minimum of three (3) simultaneous touch inputs.

A single multi-touch device promotes multi-user collaboration by allowing several individuals to stand around a device and simultaneously interact with the device. This solution has been proved by devices currently on the market. However, this solution only works well for individuals at the same physical location, within the same room.

The concept for this invention is to take current multi-touch devices a step further by offering the ability to network together various types of multi-touch devices . This networking of multi-touch devices will allow individuals at various locations to collaborate with each other. The display screens of all the multi-touch devices networked together will update in real-time. Therefore as a user touches the screen to move a digital object on the screen, all the other devices see this user's actions.

### SUMMARY

“Touch comes before sight and before speech. It is the first language and the last and it always tells the truth,” to quote award winning author Margaret Atwood. The goal of this invention is to combine the power of multi-touch devices with the server power of the Internet (also referred to as the “cloud”) to leverage multi-touch devices as a collaboration tool for individuals in remote locations.

### BRIEF DESCRIPTION OF THE DRAWINGS

FIG. 1. Illustrates the overall concept for this invention of a “host” for a session initiating with the web servers located on the “cloud” to establish a session on his/her multi-touch device, followed by individuals participating on other multi-touch devices connected to the same session.

FIG. 2. Illustrates the “host” for a session using a web page, of the web-based system, to create a user account for him/herself (if an account does not already exist).

FIG. 3. Illustrates the “host” for a session using a web page, of the web-based system, to create a new collaboration session. The “host” receives a unique alpha-numeric code to share with other individuals they invite to the specific session.

FIG. 4. Illustrates the “host” for a session using a software application on his/her multi-touch device to connect to the session with the unique session code. Also depicted, are the individuals invited by the “host” using the unique session code to connect to the same session.

### DETAILED DESCRIPTION

As previously discussed in this document, multi-touch devices can provide potential benefits to individuals in remote locations attempting to collaborate. In other words, the multi-touch device can provide, but not limited to: 1) an interactive, digital dry erase board; 2) document sharing and viewing; 3) picture and video sharing; etc.

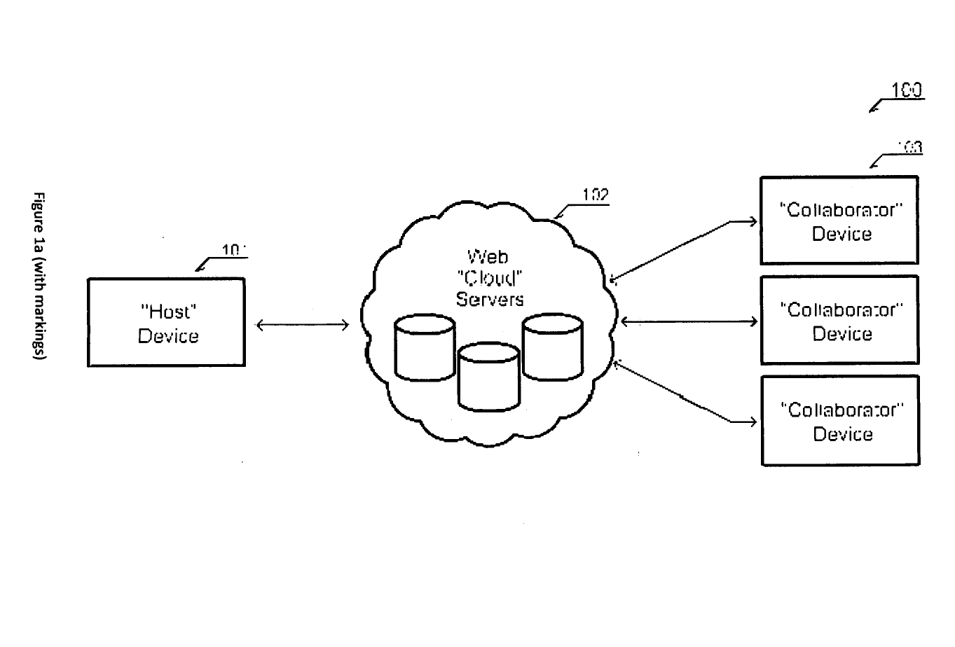

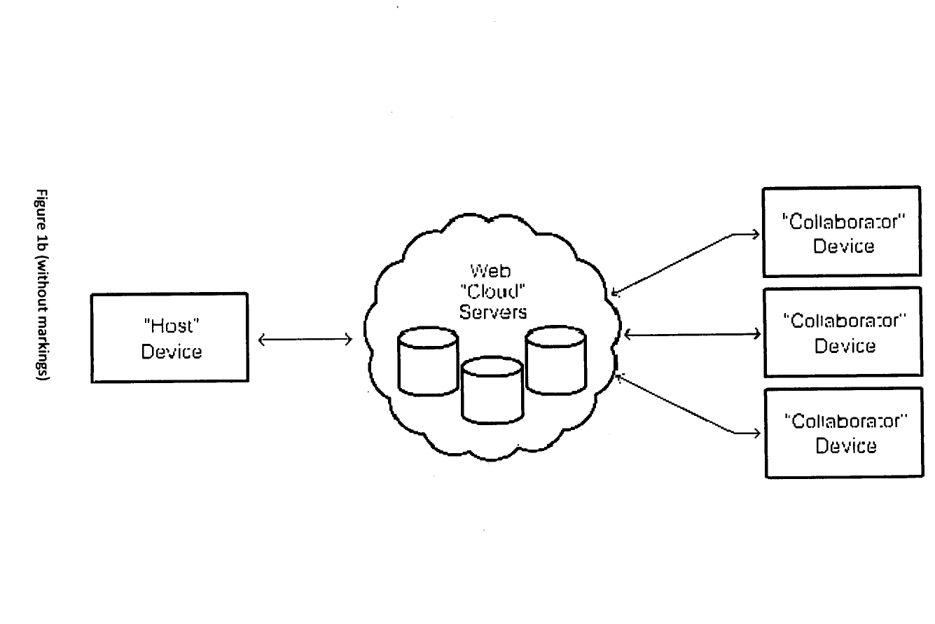

This documentation describes several web pages as part of a web-based system. The web-based system will be developed to allow for any number of sessions to be hosted, with any number of connected devices, at the same time (as shown in FIG. 1). This will allow the system to scale for a business model similar to current implementations of phone and video conference calling systems.

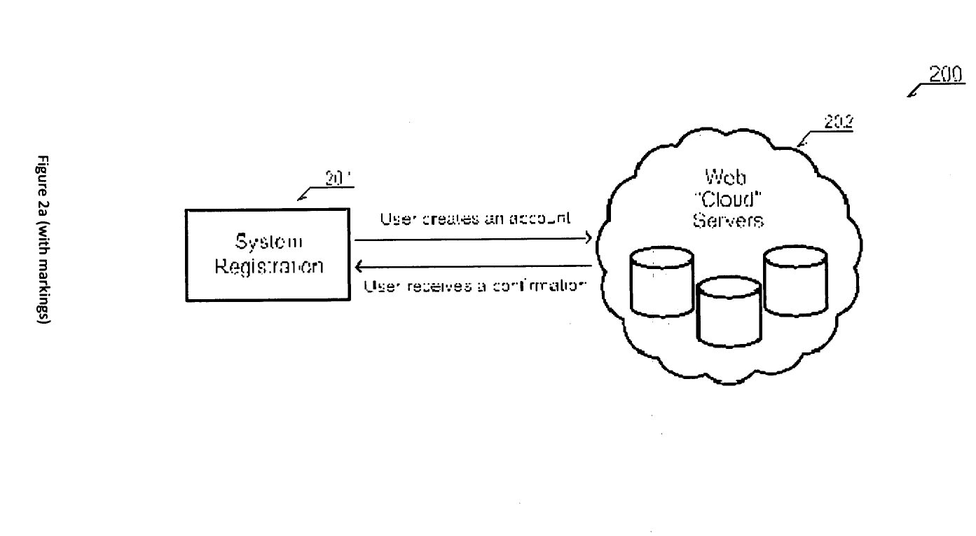

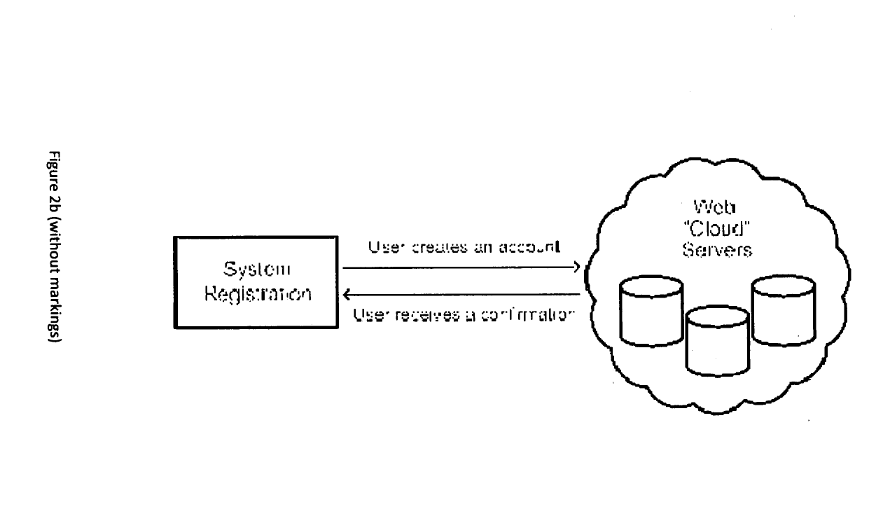

The “host” of a system will be able to use a web page as part of the web-based system to create a user account for themselves (as shown in FIG. 2). This will allow the user to schedule sessions for a specific date and time in advance. Other users and/or participants of sessions will not be required to create a user account.

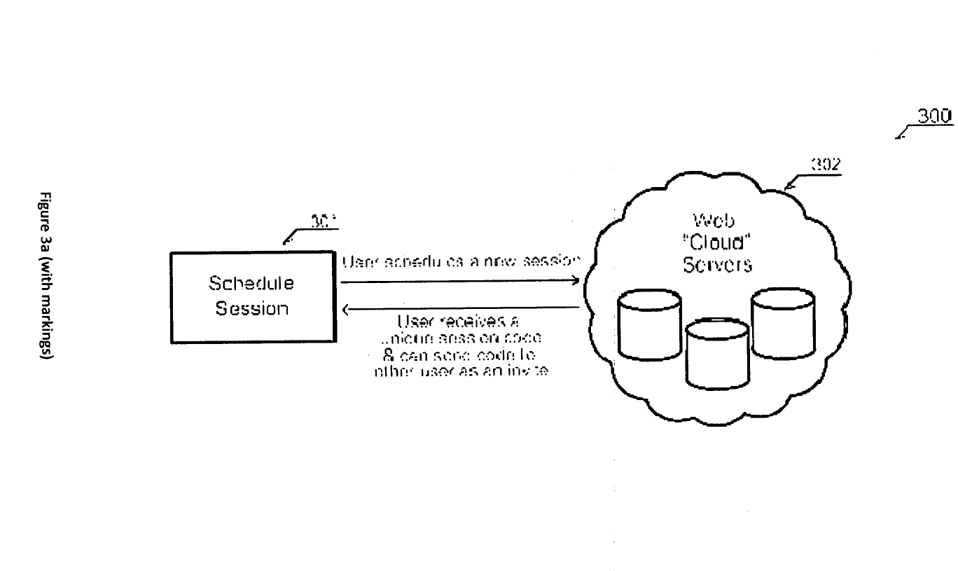

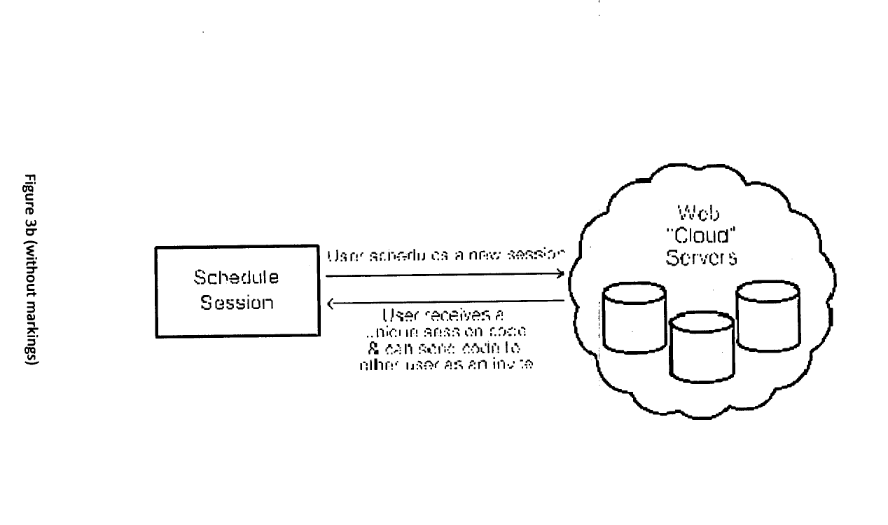

Once a “host” schedules a session with the web-based system they will receive a unique code for that session (as shown in FIG. 3). The “host” can then send the unique session code as part of their invitation to the session.

All the participants, including the “host,” will be required to have the software application specific to this invention installed on their multi-touch device. A goal of this invention will be to provide versions of the software application to be compatible with as many multi-touch devices as possible on the market.

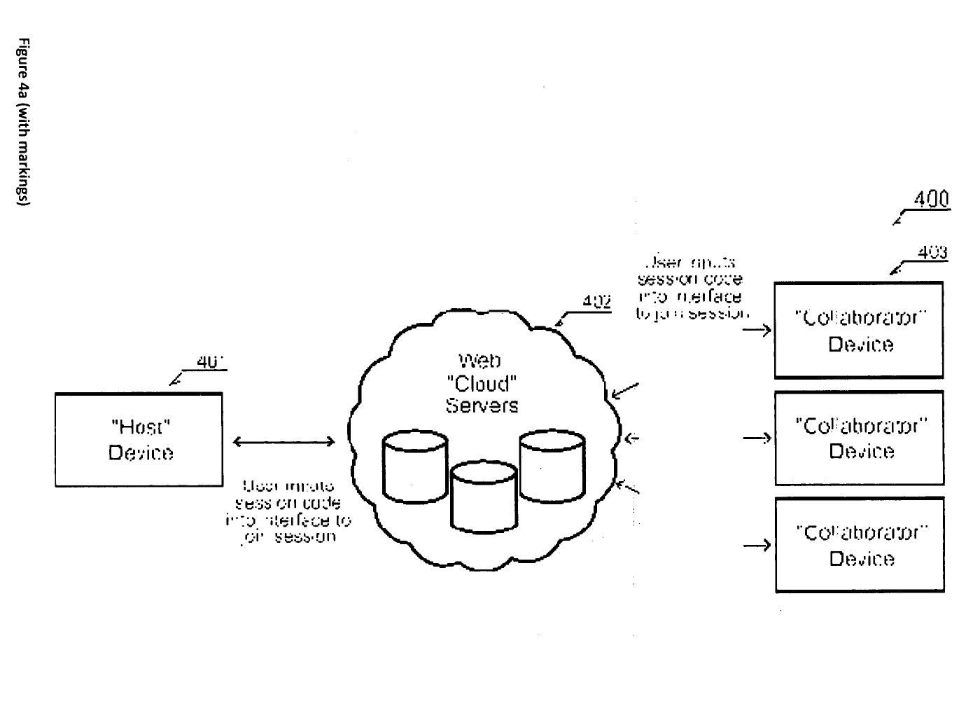

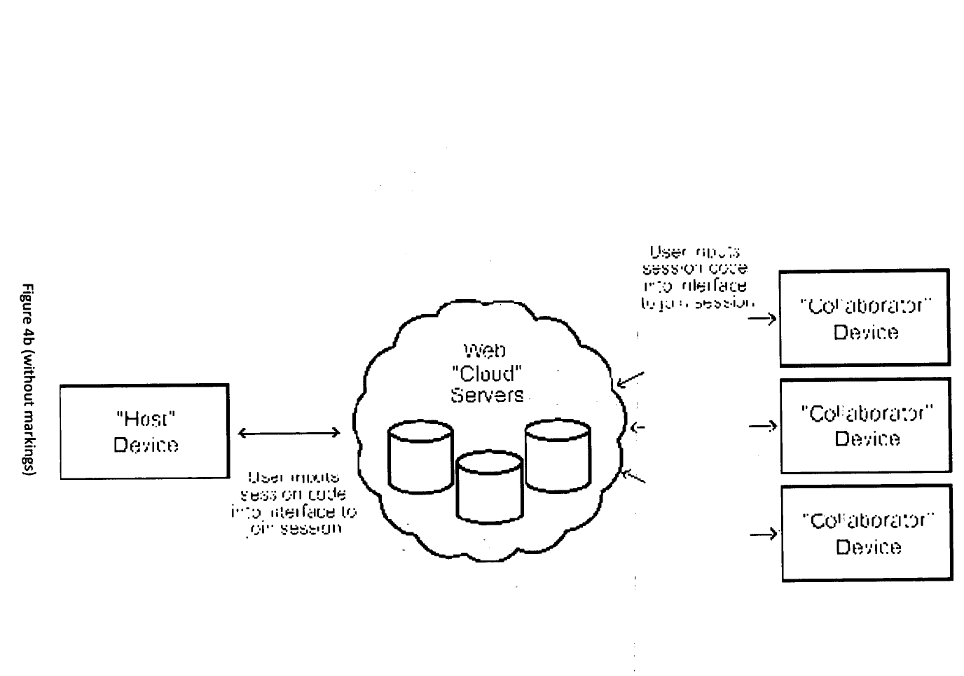

As shown in FIG. 4, each of the participants, including the “host,” will input the unique session code into the user interface of the software application (for this invention) running on their multi-touch devices. Upon successfully authentication with the web-based system, their session will begin.

Participants will be able to join sessions already underway. When this occurs the “host” will receive an alert.

As a participant observes the user interface of his/her multi-touch device, he/she will be able to see the actions of the other participants interacting with their multi-touch devices. The participant will be able to contribute to the session by interacting with his/her multi-touch device, thus allowing all the other participants to see his/her action.

Upon conclusion of the session, the “host” will be able to export information from the session to be saved to their own computer.

What is claimed is:

1. A web-enabled multi-touch system, comprising:
a web site for user management and session management that operates to allow individuals to establish a user account and profile with the system, as well as to allow users to schedule specific dates and times for sessions (which also generates the unique session codes);
a software application to run on the multi-touch devices of the system users which enables the users to connect to the system and collaborate with each other over the Internet;
a server-side software application to manage and monitor the traffic of the system for each of the scheduled sessions
